(19) United States
(12) Patent Application Publication
(10) Pub. No.: US 2017/0295131 A1
(43) Pub. Date: Oct. 12, 2017

(54) RESOURCE IDENTIFICATION THROUGH DYNAMIC DOMAIN NAME SYSTEM (DNS) LABELS

(71) Applicant: DELL SOFTWARE INC., ROUND ROCK, TX (US)

(72) Inventors: Karl Dyszynski, Lynnwood, WA (US); Steven C. Work, Bellingham, WA (US)

(21) Appl. No.: 15/217,809

(22) Filed: Jul. 22, 2016

Related U.S. Application Data
(60) Provisional application No. 62/321,661, filed on Apr. 12, 2016.

(51) Int. Cl. H04L 29/12; H04L 29/08

(52) U.S. Cl. CPC H04L 61/1511; H04L 61/2007; H04L 61/6013; H04L 67/02

(57) ABSTRACT

A single DNS NS record can establish a zone delegation to a reverse proxy access device so that the reverse proxy access device answers DNS queries directed to it under the zone delegation. A DNS label can be designated at the reverse proxy access device for each resource served by the reverse proxy access device. Upon receiving a DNS request directed to the reverse proxy access device under the zone delegation, the reverse proxy access device can use the DNS label included in a DNS request to identify the specific resource and answer with an automatically and dynamically generated A record containing the IP address of the reverse proxy access device. The client can then use the IP address to complete a TCP connection with the reverse proxy access device, after which the reverse proxy access device can use the DNS label to complete the request to the appropriate resource.

### CROSS REFERENCE TO RELATED APPLICATIONS

This application claims the priority benefit of U.S. provisional application No. 62/321,661, filed on Apr. 12, 2016, which is expressly incorporated by reference herein in its entirety.

### BACKGROUND OF THE INVENTION

### Field of the Invention

The present technology pertains to resource identification, and more specifically pertains to resource identification through dynamic DNS labels.

### Description of the Related Art

Reverse proxy access devices are often utilized to answer web requests in a private network. For example, a reverse proxy access device can sit behind the firewall in a private network to direct web requests to the intended resource. Currently, reverse proxy access devices utilize several techniques to identify the intended resource of a particular web request. One such technique is address mapping, which requires a separate Internet Protocol (IP) address be designated for each resource (either on a separate interface or on a network interface shared with other IP addresses). The reverse proxy access device can be configured to recognize web requests to a specific IP address as intended for a specific resource.

Another technique is hostname mapping, which requires a separate DNS Fully Qualified Domain Name (FQDN) be created for each resource and associated with an Address (A) record mapping the FQDN to the reverse proxy access device's IP address. The reverse proxy access device can be configured to recognize web request to a specific FQDN as intended for a specific resource.

A third technique is port-mapping, which requires the reverse proxy access device to listen for web requests and recognize that a request to a specific port is intended for a specific resource. Each of these three techniques is awkward to manage and requires coordination between each supported resource and outside services, which may be under different administrative control than the reverse proxy access device itself.

A fourth technique is translation and requires information be encoded into the Uniform Resource Identifier (URI) that identifies a specific resource along with the resource's URI information. The reverse proxy access device decodes the URI information in each web request to identify the specific resource as well as preserve/restore the specific resource's URI information. This technique is computationally intensive and requires that significant resources be devoted to decoding each web request. As a result, the number of users that the reverse proxy access device can support may be limited. Accordingly, improvements are needed.

### SUMMARY OF THE CLAIMED INVENTION

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for resource identification through dynamic DNS labels. Resource identification through dynamic DNS labels provides an improved technique for reverse proxy access devices to identify the intended resource of a particular web request. A single DNS Name Server (NS) record can be used to establish a zone delegation to a reverse proxy access device so that the reverse proxy access device answers DNS queries directed to it under the zone delegation. A DNS label (e.g., name, identifier, etc.) can be designated at the reverse proxy access device for each resource served by the reverse proxy access device. Upon receiving a DNS request directed to the reverse proxy access device under the zone delegation, the reverse proxy access device can use the DNS label included in a DNS request to identify the specific resource and answer with an automatically and dynamically generated Address (A) record containing the IP address of the reverse proxy access device. The client can then use the IP address to complete a Transmission Control Protocol (TCP) connection with the reverse proxy access device, after which the reverse proxy access device can use the DNS label to complete the request to the appropriate resource.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of computing devices and a network in accordance with the invention.

FIG. 2 illustrates an example method of resource identification through dynamic DNS labels.

FIGS. 3A and 3B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for resource identification through dynamic DNS labels. Resource identification through dynamic DNS labels provides an improved technique for reverse proxy access devices to identify the intended resource of a particular web request. A single DNS NS record can be used to establish a zone delegation to a reverse proxy access device so that the reverse proxy access device answers DNS queries directed to it under the zone delegation. A DNS label (e.g., name) can be designated at the reverse proxy access device for each resource served by the reverse proxy access device. Upon receiving a DNS request directed to the reverse proxy access device under the zone delegation, the reverse proxy access device can use the DNS label included in a DNS request to identify the specific resource and answer with an automatically and dynamically generated A record containing the IP address of the reverse proxy access device. The client can then use the IP address to complete a TCP connection with the reverse proxy access device, after which the reverse proxy access device can use the DNS label to complete the request to the appropriate resource.

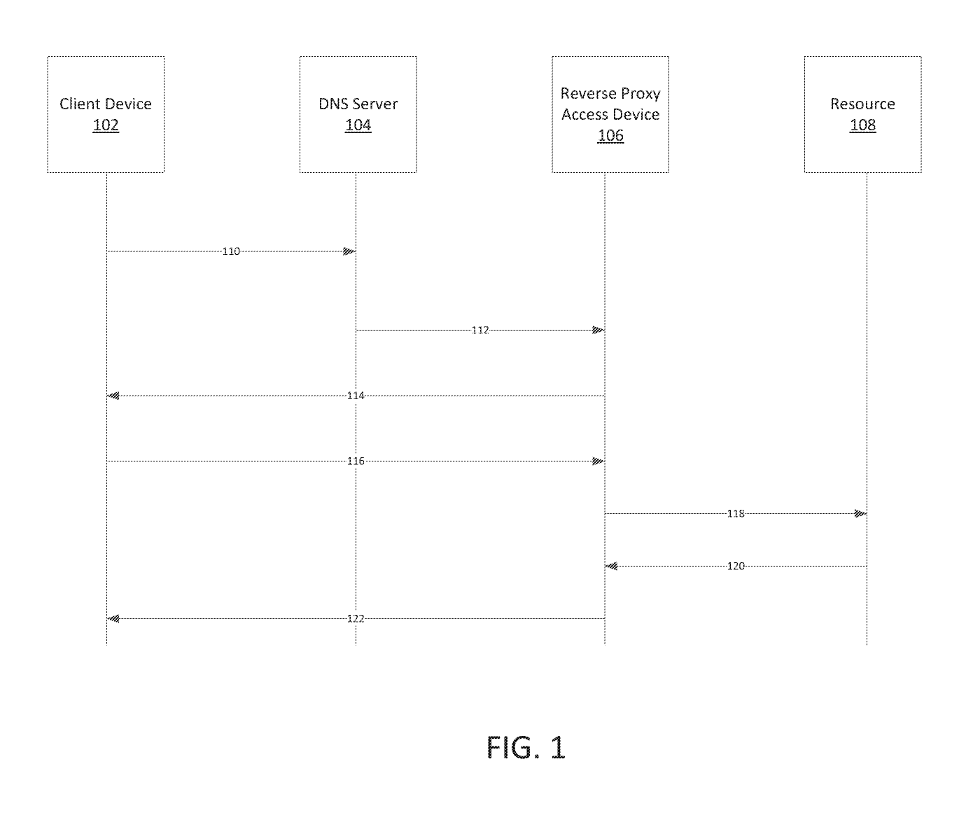

FIG. 1 illustrates an exemplary configuration 100 of computing devices and a network in accordance with the invention. The computing devices can be connected to a communication network and be configured to communicate with each other through use of the communication network. A communication network can be any type of network, including a local area network (“LAN”), such as an intranet, a wide area network (“WAN”), such as the internet, or any combination thereof. Further, a communication network can be a public network, a private network, or a combination thereof. A communication network can also be implemented using any number of communication links associated with one or more service providers, including one or more wired communication links, one or more wireless communication links, or any combination thereof. Additionally, a communication network can be configured to support the transmission of data formatted using any number of protocols.

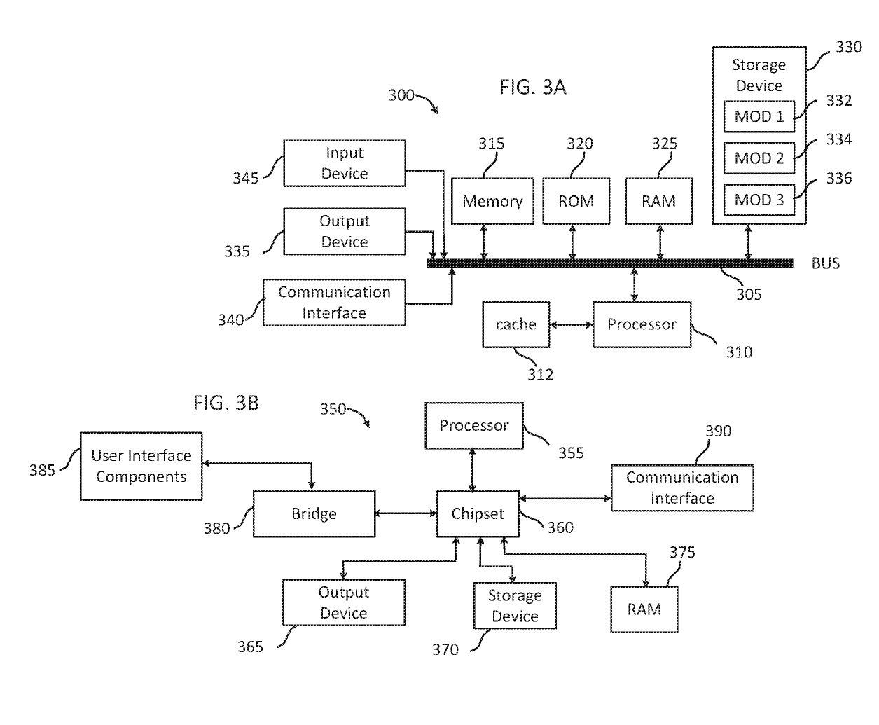

A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 300 of FIGS. 3A and 3B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As shown, system 100 includes 4 computing device: client device 102, DNS server 104, reverse proxy access device 106 and resource 108. A user can use client device 102 to transmit a web request to access resource 108, which can be managed by reverse proxy access device 106. Client device 102 can transmit web request 110 using a FQDN that includes a DNS label associated with resource 108. For example, client device 102 can transmit web request 110 as a result of a user selecting a hyperlink on a web portal page. Web request 110 can be received by DNS server 104, which can use the FQDN to identify a corresponding record. To cause web request 110 to be routed to reverse proxy access device 106, a single DNS NS record can be used to establish a zone delegation to reverse proxy access device 106 so that reverse proxy access device 106 answers DNS queries directed to it under the zone delegation. DNS server 104 can use the data included in the FQDN to identify the DNS NS record and transmit DNS request 112 to reverse proxy access device 106. DNS request 112 can include the DNS label and other data included in web request 110.

A DNS label can be designated at reverse proxy access device 106 for each resource served by reverse proxy access device 106. Reverse proxy access device 106 can publish the DNS labels to allow clients to discover the DNS labels. For example, reverse proxy access device 106 can generate resource links including the DNS labels and publish the resource links to a portal page accessible to users.

Upon receiving DNS request 112 directed to reverse proxy access device 106 under the zone delegation, reverse proxy access device 106 can automatically and dynamically generate an A record containing the IP address of reverse proxy access device 106 and transmit answer 114 to client device 102 that includes the IP address.

Client device 102 can then use the IP address received in answer 114 to complete TCP connection 116 with reverse proxy access device 116. Reverse proxy access device 106 can use the DNS label to identify resource 108, Reverse proxy access device 106 can then request 118 and receive 120 data from resource 108, which can then be provided 122 to client device 102 to complete web request 110.

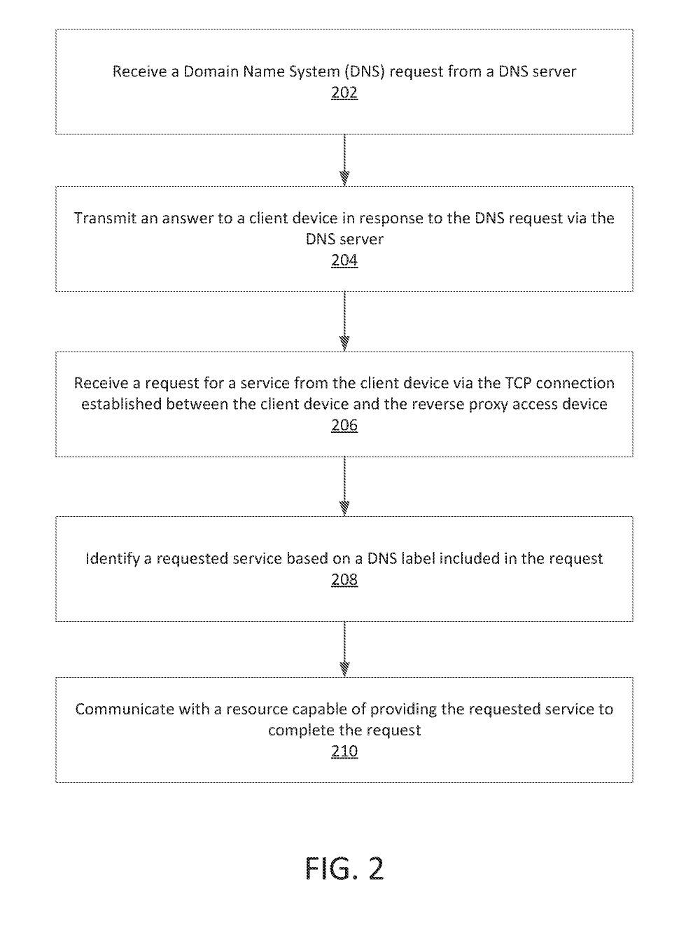

FIG. 2 illustrates an example method of resource identification through dynamic DNS labels. It should be understood that there can be additional, fewer, or alternative steps performed in similar or alternative orders, or in parallel, within the scope of the various embodiments unless otherwise stated.

At step 202, a reverse proxy access device can receive a Domain Name System (DNS) request from a DNS server. The DNS server can include a first Name Server (NS) record establishing a zone delegation to the reverse proxy access device that causes the DNS request to be directed to the reverse proxy access device under the zone delegation. For example, a client device can transmit a request to the DNS server using a FQDN. The DNS server can use the FQDN to identify the NS record and then forward the DNS request to reverse proxy access device under the zone delegation.

The DNS request can include a DNS label that corresponds to a requested service. For example, the reverse proxy access device can maintain a DNS table that lists DNS labels and their corresponding services. The reverse proxy access device can generate resource links including the one or more DNS labels, and publish the resource links to a portal page accessible to users. A resource link can be selected and/or otherwise used to transmit a request for a service corresponding to the DNS label included in the resource link. For example, a client device can transmit a request to the DNS server as a result of a selection of one of the resource link published on the portal page. The transmitted request can include the DNS label included in the resource link.

At step 204, the reverse proxy access device can transmit an answer to a client device in response to the DNS request via the DNS server. The answer can include an automatically and dynamically generated Address (A) record including an Internet Protocol (IP) address of the reverse proxy access device. For example, the reverse proxy device can generate the A record in response to receiving the DNS request. The client device can use the IP address to communicate with the reverse proxy access device to establish a Transmission Control Protocol (TCP) connection. For example, the client device can use the IP address to transmit a request to the reverse proxy access device to establish the TCP connection and the reverse proxy access device can establish the TCP connection between the client device and the reverse proxy access device in response to receiving the request.

At step 206, the reverse proxy access device can receive a request for a service from the client device via the TCP connection established between the client device and the reverse proxy access device. The request can include the DNS label.

At step 208, the reverse proxy access device can identify a requested service based on a DNS label included in the request. For example, the reverse access proxy device can search a DNS table based on the DNS label included in the request. The DNS table can list one or more DNS labels and services corresponding to the one or more DNS labels. The reverse access proxy device can use the DNS table to identify the service corresponding to the DNS label included in the request.

At step 210, the reverse access proxy device can communicate with a resource capable of providing the requested service to complete the request. For example, the reverse access proxy device can identify a set of resources capable of providing the requested service and select a resource capable of providing the requested service from the set of resources. The reverse access proxy access device can then communicate with selected resource to complete the request.

FIGS. 3A and 3B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 3A illustrates a conventional system bus computing system architecture 300 wherein the components of the system are in electrical communication with each other using a bus 305. Exemplary system 300 includes a processing unit (CPU or processor) 310 and a system bus 305 that couples various system components including the system memory 315, such as read only memory (ROM) 320 and random access memory (RAM) 325, to the processor 310. The system 300 can include a cache of high-speed memory connected directly with, in close proximity to, or integrated as part of the processor 310. The system 300 can copy data from the memory 315 and/or the storage device 330 to the cache 312 for quick access by the processor 310. In this way, the cache can provide a performance boost that avoids processor 310 delays while waiting for data. These and other modules can control or be configured to control the processor 310 to perform various actions. Other system memory 315 may be available for use as well. The memory 315 can include multiple different types of memory with different performance characteristics. The processor 310 can include any general purpose processor and a hardware module or software module, such as module 1 332, module 2 334, and module 3 336 stored in storage device 330, configured to control the processor 310 as well as a special-purpose processor where software instructions are incorporated into the actual processor design. The processor 310 may essentially be a completely self-contained computing system, containing multiple cores or processors, a bus, memory controller, cache, etc. A multi-core processor may be symmetric or asymmetric.

To enable user interaction with the computing device 300, an input device 345 can represent any number of input mechanisms, such as a microphone for speech, a touch-sensitive screen for gesture or graphical input, keyboard, mouse, motion input, speech and so forth. An output device 335 can also be one or more of a number of output mechanisms known to those of skill in the art. In some instances, multimodal systems can enable a user to provide multiple types of input to communicate with the computing device 300. The communications interface 340 can generally govern and manage the user input and system output. There is no restriction on operating on any particular hardware arrangement and therefore the basic features here may easily be substituted for improved hardware or firmware arrangements as they are developed.

Storage device 330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 325, read only memory (ROM) 320, and hybrids thereof.

The storage device 330 can include software modules 332, 334, 336 for controlling the processor 310. Other hardware or software modules are contemplated. The storage device 330 can be connected to the system bus 305. In one aspect, a hardware module that performs a particular function can include the software component stored in a computer-readable medium in connection with the necessary hardware components, such as the processor 310, bus 305, display 335, and so forth, to carry out the function.

FIG. 3B illustrates a computer system 350 having a chipset architecture that can be used in executing the described method and generating and displaying a graphical user interface (GUI). Computer system 350 is an example of computer hardware, software, and firmware that can be used to implement the disclosed technology. System 350 can include a processor 355, representative of any number of physically and/or logically distinct resources capable of executing software, firmware, and hardware configured to perform identified computations. Processor 355 can communicate with a chipset 360 that can control input to and output from processor 355. In this example, chipset 360 outputs information to output 365, such as a display, and can read and write information to storage device 370, which can include magnetic media, and solid state media, for example. Chipset 360 can also read data from and write data to RAM 375. A bridge 380 for interfacing with a variety of user interface components 385 can be provided for interfacing with chipset 360. Such user interface components 385 can include a keyboard, a microphone, touch detection and processing circuitry, a pointing device, such as a mouse, and so on. In general, inputs to system 350 can come from any of a variety of sources, machine generated and/or human generated.

Chipset 360 can also interface with one or more communication interfaces 390 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 355 analyzing data stored in storage 370 or 375. Further, the machine can receive inputs from a user via user interface components 385 and execute appropriate functions, such as browsing functions by interpreting these inputs using processor 355.

It can be appreciated that exemplary systems 300 and 350 can have more than one processor 310 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for identifying a requested service by a reverse proxy access device, the method comprising:
receiving a Domain Name System (DNS) request from a DNS server, the DNS server including a first Name Server (NS) record establishing a zone delegation to the reverse proxy access device, wherein the DNS request was directed to the reverse proxy access device under the zone delegation;
transmitting an answer to a client device in response to the DNS request via the DNS server, the answer including an automatically and dynamically generated Address (A) record including an Internet Protocol (IP) address of the reverse proxy access device;
receiving a request for a service from the client device via a Transmission Control Protocol (TCP) connection established between the client device and the reverse proxy access device, wherein the client device used the IP address to establish the TCP connection with the reverse proxy access device;
identifying a requested service based on a DNS label included in the request; and
communicating with a resource capable of providing the requested service to complete the request.

2. The method of claim 1, wherein identifying the requested service based on the DNS label comprises searching a DNS table based on the DNS label included in the request, wherein the DNS table lists one or more DNS labels and services corresponding to the one or more DNS labels.

3. The method of claim 2, further comprising:
generating resource links including the one or more DNS labels; and
publishing the resource links to a portal page accessible to users.

4. The method of claim 3, wherein the DNS request was transmitted by the client device as a result of a selection of a first resource link published on the portal page, the first resource link including the DNS label.

5. The method of claim 1, further comprising:
identifying a set of resources capable of providing the requested service; and
selecting the resource capable of providing the requested service from the set of resources.

6. The method of claim 1, further comprising establishing the TCP connection between the client device and the reverse proxy access device.

7. The method of claim 1, further comprising generating the A record in response to receiving the DNS request.

8. A reverse proxy access device, comprising:
one or more computer processors; and
a memory storing instructions that, when executed by the one or more computer processors, cause the reverse proxy access device to:
receive a Domain Name System (DNS) request from a DNS server, the DNS server including a first Name Server (NS) record establishing a zone delegation to the reverse proxy access device, wherein the DNS request was directed to the reverse proxy access device under the zone delegation;
transmit an answer to a client device in response to the DNS request via the DNS server, the answer including an automatically and dynamically generated Address (A) record including an Internet Protocol (IP) address of the reverse proxy access device;
receive a request for a service from the client device via a Transmission Control Protocol (TCP) connection established between the client device and the reverse proxy access device, wherein the client device used the IP address to establish the TCP connection with the reverse proxy access device;
identify a requested service based on a DNS label included in the request; and
communicate with a resource capable of providing the requested service to complete the request.

9. The reverse proxy access device of claim 8, wherein identifying the requested service based on the DNS label comprises searching a DNS table based on the DNS label included in the request, wherein the DNS table lists one or more DNS labels and services corresponding to the one or more DNS labels.

10. The reverse proxy access device of claim 9, wherein the instructions further cause the reverse proxy access device to:
generate resource links including the one or more DNS labels; and
publish the resource links to a portal page accessible to users.

11. The reverse proxy access device of claim 10, wherein the DNS request was transmitted by the client device as a result of a selection of a first resource link published on the portal page, the first resource link including the DNS label.

12. The reverse proxy access device of claim 8, wherein the instructions further cause the reverse proxy access device to:
identify a set of resources capable of providing the requested service; and
select the resource capable of providing the requested service from the set of resources.

13. The reverse proxy access device of claim 8, wherein the instructions further cause the reverse proxy access device to establish the TCP connection between the client device and the reverse proxy access device.

14. The reverse proxy access device of claim 8, wherein the instructions further cause the reverse proxy access device to generate the A record in response to receiving the DNS request.

15. A non-transitory computer-readable medium storing instructions that, when executed by a reverse proxy access device, cause the reverse proxy access device to:
receive a Domain Name System (DNS) request from a DNS server, the DNS server including a first Name Server (NS) record establishing a zone delegation to the reverse proxy access device, wherein the DNS request was directed to the reverse proxy access device under the zone delegation;
transmit an answer to a client device in response to the DNS request via the DNS server, the answer including an automatically and dynamically generated Address (A) record including an Internet Protocol (IP) address of the reverse proxy access device;
receive a request for a service from the client device via a Transmission Control Protocol (TCP) connection established between the client device and the reverse proxy access device, wherein the client device used the IP address to establish the TCP connection with the reverse proxy access device;
identify a requested service based on a DNS label included in the request; and
communicate with a resource capable of providing the requested service to complete the request.

16. The non-transitory computer-readable medium of claim 15, wherein identifying the requested service based on the DNS label comprises searching a DNS table based on the DNS label included in the request, wherein the DNS table lists one or more DNS labels and services corresponding to the one or more DNS labels.

17. The non-transitory computer-readable medium of claim 16, wherein the instructions further cause the reverse proxy access device to:
generate resource links including the one or more DNS labels; and
publish the resource links to a portal page accessible to users.

18. The non-transitory computer-readable medium of claim 17, wherein the DNS request was transmitted by the client device as a result of a selection of a first resource link published on the portal page, the first resource link including the DNS label.

19. The non-transitory computer-readable medium of claim 15, wherein the instructions further cause the reverse proxy access device to:
identify a set of resources capable of providing the requested service; and
select the resource capable of providing the requested service from the set of resources.

20. The non-transitory computer-readable medium of claim 15, wherein the instructions further cause the reverse proxy access device to establish the TCP connection between the client device and the reverse proxy access device.
